(19) United States
(12) Patent Application Publication
(10) Pub. No.: US 2005/0134738 A1
(43) Pub. Date: Jun. 23, 2005

(54) Television picture or image enhancer

(76) Inventor: William Redvers Belisle, New Orleans, LA (US)

Correspondence Address: WILLIAM REDVERS BELISLE, 7901 Lafourche Street, New Orleans, LA, 70127, US

(21) Appl. No.: 10/820,268

(22) Filed: Apr. 8, 2004

Related U.S. Application Data
(63) Continuation-in-part of application No. 09/602,236, filed on Jun. 23, 2000, now abandoned.

(51) Int. Cl. H04N 5/213

(52) U.S. Cl. 348/581

(57) ABSTRACT

A television picture or image enhancing system comprised of an apparatus and method for varying the vision prescription through which television pictures or images are perceived. The apparatus may be attached to or about a television or may be located about a television. The television pictures or images may be enhanced by television picture or image vision prescription signal manipulation. The vision prescription enhanced pictures or images produced per the present invention may be more clearly perceived by non-20/20 or poor vision viewers than the non-vision prescription enhanced picture or image received from present televisions.

### STATEMENT REGARDING FEDERALLY SPONSORED RESEARCH OR DEVELOPMENT

Not Applicable

### BACKGROUND OF THE INVENTION

1. Field of the Invention/Technical Field

The following is ‘A statement of the field of art to which the invention pertains:
1. U.S. Class: 348
   Field of Search: 348/554; 348/581; 348/423
2. U.S. Class: 358
   Field of Search: 358/231; 358/237; 358/250; 358/255; 358/335
3. U.S. Class: 340
Field of Search: 340/324AD

2. Description of the Related Art

Numerous patents and proposals describe television signal reception, conversion, decoding, and output, picture size manipulation within a particular television screen, and simultaneous picture depiction (Lee, 2000; Kim, 2000; Bando, et al., 2000; Hamill, 1978; Hutt, et al., 1977; Bogner, 1989). Dougherty (1977) and Inglis (1948) describe a television receiver with screen and magnifier which may be attached directly to or away from the screen.

The patents and proposals described above do not describe the enhancement of television pictures or images with regard to vision and perception from a television or television screen involving perception, as in a prescription for vision or in an eye-glass prescription enhanced television picture or image. The above described patents and proposals are also generally associated with broadcasted television signal reception, conversion, decoding, and output. The above described patents do not describe the manipulation of broadcasted television signals, screens, or other devices involving eye glass type vision prescription enhanced perception of television pictures or images.

To overcome these shortcomings, the present invention provides enhancement of television pictures or images with regard to vision and perception, as pertaining to eye glass type vision prescriptions, from a television or television screen. The present invention contributes to the ease and convenience with which television pictures or images may be viewed or perceived through the provision of pictures or images which may be viewed per prescribed or prescription vision requirements.

### BRIEF SUMMARY OF THE INVENTION

It is the objective of the invention to provide enhanced perception of television pictures or images to include eye glass type vision prescription

### BRIEF DESCRIPTION OF SEVERAL VIEWS OF THE DRAWINGS

The present invention will be more fully understood by references to the following brief description thereof when read in conjunction with the attached drawings, and wherein:

FIG. 1. Front cross-sectional view of a) a television showing a picture or image which can be perceived or viewed clearly with 20/20 vision or approximately 20/20 vision and b) a television showing a distorted television picture or image (as viewed by an individual requiring prescription eye glasses to see clearly and the individual is not wearing required prescription lenses) which can be perceived or viewed clearly with non 20/20 vision or poor vision using the vision prescription enhancing system.

### DETAILED DESCRIPTION OF THE INVENTION

(References are to Illustrations)

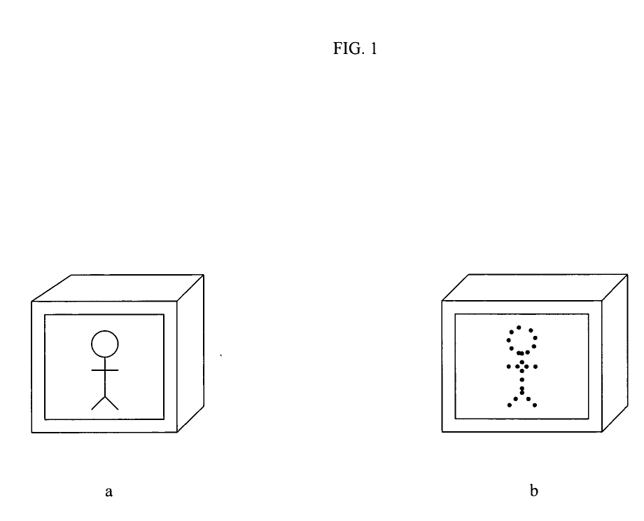

Television screens may be constructed with vision prescriptions made or incorporated into or about the screen. Television screens are also constructed as to cause the television picture or image to be perceived or viewed per a particular vision prescription or range of vision prescriptions. Television screens may be constructed with vision prescriptions enhanced devices made about the screen such as a vision prescription lens or device built in front of or about the television and television screen. With regard to the manipulation of broadcast signals delivering vision prescription enhanced pictures or images on or about television screens, the television signal may be non-20/20 vision, as compared to 20/20 vision or clear perception, as to produce vision prescribed enhanced pictures or images on the television screen. The device produces said variations on a screen or picture or image viewing apparatus attached to or remotely located regarding the location of the television. The reproduction of pictures or images on or from a television screen may also be accomplished by picture or image signal manipulation. With regard to the manipulation of broadcast signals delivering vision prescription enhanced pictures or images on or about television screens, the normal television signal may be manipulated by an attached or non-attached device that may enhance the perception of the pictures or images for prescribed or prescription vision. The vision prescription enhancing device, relative to the television screen, must be positioned such that the perception of the prescription enhanced picture or image is optimized. The present invention consists of television picture or image enhancing devices which allow picture or image perception variation regarding vision prescription for the television through directly attached, indirectly attached, or remote means (See FIG. 1). Perception variation is accomplished by the invention through the production of pictures or images which may be perceived or viewed per eye glass type vision prescription (See FIG. 1).

As shown in FIG. 1, the present invention is made to allow pictures or images on a television to be perceived or viewed clearly with 20/20 vision or non 20/20 or poor vision. Vision prescriptions for television picture or image enhancement may be incorporated into or with the broadcasted television signals. The pictures or images may be broadcasted to the television with pictures or images that can be perceived clearly by non-20/20 or poor vision viewers or may be further enhanced by the present invention being located about or within the television screen. Vision prescription enhanced television picture or image perception may have a range of vision prescriptions. The broadcasted television signal may be ‘focused’ or manipulated as to incorporate the specifications of the desired vision prescription.

The television prescription lens or screens, the television signal prescription receiving and manipulating devices, and the focused television broadcast signals include vision prescription components including a) the base (spherical) strength and type (plus or minus), b) the cylinder strength and type, c) the cylinder axis orientation, and d) the strength of bifocal segment (if needed). These vision prescription components must be incorporated in the vision prescription lens, screens, filters, films, broadcast signal or signal manipulation used to incorporate vision prescriptions for non 20/20 and poor television viewing or pictures or images.

The surfaces on which television signals are received and from which the television picture or image is viewed or perceived by the viewer are made to incorporate or include the three or four components of eye vision prescriptions. Generally, glass, plastic, and similar materials are ground, are generally spherical but not necessarily round in shape, and use the general principles of optics to determine the dimensions of the television screen, viewing surface, or for the present invention, the television lens. In the case of non-glass type viewing surfaces, either films or other ‘in-between’ prescription devices, or non-glass type prescription containing viewing surfaces are used. The ground lenses or viewing surfaces may be sanded, shaped, and smoothed. Television viewing surfaces including lenses and other non-glass type viewing surfaces may be made and fitted into new or old television systems as to fit various television shapes, sizes, and apparatus. Television prescription film containing or causing vision prescriptions to be incorporated into the viewed picture or image may be placed on, in front of, or behind television picture or image viewing surfaces. The film, which may be similar to soft contacts or other material, also contain the three or four components of vision prescriptions.

The vision prescription television lenses, screens, filters or films, and viewing surfaces may be cut, shaped, and designed to fit any of the various present and new televisions. The vision prescription television screens and viewing surfaces may be made into or onto old, new, and present televisions. The vision prescription television screens and viewing surfaces may be made into or onto televisions in the conventional method by which television screens and viewing surfaces are repaired, modified, or made into or onto televisions. Vision prescription lenses that are placed in front of or behind the television screen or viewing surface are made similarly to the initially discussed vision prescription lenses, screens, or viewing surfaces and must be positioned as to produce an appropriate focal point for appropriate non 20/20 and poor vision viewing.

Considering the processes involved in resolution, television picture or image vision prescription may be applied to screens by manipulating the pixels on the screen to reflect the application of vision prescription. Television picture or image vision prescription may be applied to the perception of television pictures or images by manipulating the coatings, films, or etc. to reflect the application of vision prescriptions. Television picture or image vision prescription may be applied to the perception of television pictures or images by manipulating the components of the signal receiving device to reflect the application of vision prescription. The perception of vision prescription television pictures or images is accomplished by applying vision prescription technologies such as lenses, coatings, films, pixel manipulation, etc. on or about the components of the receiver. Television picture or image vision prescription may be applied to screens by manipulating the pixels on the screen to reflect the application of vision prescription.

The methods used to produce television picture or image enhancing systems which allow variation in the perception, as in prescription for vision, of the picture or image from a television include the use of lenses or screens, filters or films, coatings, signal receiving and manipulating devices, and focused television broadcast signals. Multiple or mixed lenses or screens, filters or films, signal receiving and manipulating devices, and focused television broadcast signals may also be incorporated to produce the appropriate vision prescription viewing surface. Simple, complex, or other types of lenses or screens, filters or films, signal receiving and manipulating devices, and focused television broadcast signals may be used to make the present vision prescription invention.

Devices such as vision prescription containing or manipulating lenses, films, and television signal prescription converting devices may be placed between the viewer and the television picture or image viewing surface, between the original television signal and the viewer, between the original television signal and the television, or between the viewing surface and the original television signal. These devices include the three or four components of vision prescriptions and cause the television picture or image to be viewed clearly with a particular non 20/20 or poor vision. The focusing or vision prescription producing lens, filter, or other device must be positioned on or in the screen or picture or image viewing surface, between television and viewer, between television company's initial television signal and satellite or cable or television signal receiver, between the television company's initial television signal and the television, between the television and the viewer, between the initial television signal and the viewer, or between the satellite or cable or receiver and the viewer.

Similar to cable television boxes that must generally be connected and configured between the original television signal and the television, television prescription manipulating devices may also be incorporated between the original television signal and the television for the present invention. The television prescription box may contribute to the delivery of a particular vision prescription picture or image already containing the components of vision prescriptions or may contribute to the focusing or conversion of television signals into television prescription signals.

Vision prescription television signals may be produced by placing a lens containing and producing the three of four components of vision prescriptions appropriately between the original television signal and the television picture or image viewer. The prescription television signals may also be focused or produced using vision prescription components producing technology which may allow the manipulation of television broadcast signals incorporating the three or four vision prescription components.

Television signals or information may contact the viewing surface with and containing, or without and not containing, the vision prescription components. The resulting television picture or image must be able to be viewed clearly by a viewer requiring a particular vision prescription at a particular distance from the television or from a given area. Vision prescription television pictures or images must be able to be viewed clearly if the original television signal is broadcast with or containing vision prescription. Hence the clear, present, 20/20 vision viewing surface must contribute to a clear perception of the non 20/20 or poor vision prescription pictures or images. Television signals without and not containing vision prescription must contact the viewing surface in a manner as to allow the television signal to be appropriately focused or manipulated by the television prescription lens as to produce appropriate vision prescription enhanced pictures or images for the viewer.

Television picture or image vision prescriptions are made by applying vision prescription technologies such as lenses, coatings, films, pixel manipulation, signal manipulation, etc. to (on or about) various components of cable modems and such devices including the tuner, demodulator, modulator, media access control device, and the microprocessor. Television picture or image vision prescriptions are also made by applying similar technologies to the signal from the cable modem to the television, key board, or computer. Television picture or image vision prescriptions are also made by applying similar technologies to the cable headend transmitters, the cable modem termination system, or the internet connection or signal.

Television broadcast signals and other television information are broadcasted through air (involving antennas, satellites, receivers, etc.) and may also be delivered by cable type devices. The broadcasting and delivery of vision prescription television signals to the viewer are done in such a manner that the television signal or other information are viewed or perceived clearly by the non 20/20 or poor television viewer. The television picture or image is viewed or perceived clearly by a viewer with non 20/20 vision.

Regarding the broadcast or transmittal of prescription vision pictures or images, television signal focusing for vision prescription television picture or image production may be done a) in the television camera lens(es), b) in the image or moving image scanning phase, c) as the electronic signal is transmitted or sent, d) or as the pictures or images are received by the receiver or monitor. Vision prescription lens or other vision prescription coatings, films, and methods may be incorporated a) into or about one or more camera lenses, b) within the camera housing, c) within or about pick-up-devices, d) within or about the viewfinder, e) within or about the camera tube or charge-coupled device or signal receiving device, f) on or about the monitor, or g) within or about the electronic signal. Television picture or image vision prescriptions are made in or about the cathode ray tube or CRT used for image display. Television picture or image vision prescription are made on or about the CRT including the cathode, conductive coating, the anode, the phosphor-coated screen, electron beams and image or picture painting, and the shadow mask. Vision prescriptions may be incorporated into television signals or pictures or images as signals are mixed with video signals (from video tape players, computers, film chains or telecines), or in or about the switcher (combines or mixes signals).

Television vision prescription pictures and images are made into broadcast programming received through an antenna, VCR or DVD players that connect to the antenna terminals, cable TV and the set-top box, and satellites and satellite dishes including geosynchronous orbit. This also includes the composite TV signal, the vestigial picture sideband, the video carrier, the fully transmitted picture sideband, and the sound carrier. Television vision prescription pictures and images are made into or about microwave transmitters, receiving towers, and for community antenna television.

Prescription vision television signals are broadcasted similar to cable television signal broadcasting. The signals are focused using lenses, films, filters, coating, or computer assisted vision prescription and optical techniques including vision prescription producing techniques, and to include television and computer coupling techniques, to produce television signals and picture or images with vision prescription. The focusing or image or picture producing method may be included in the complete video signal, the transmitter or transmitting method including the carrier wave, the receiving device, the wire through which the signal is sent or transmitted, through a device in the air through which the signal travels, the antenna, from video players, the satellite, or the monitor by which the picture or image is viewed. The television signal is focused as to reflect vision prescriptions and to contain the necessary parts of vision prescriptions.

Television picture or image vision prescription is made in or about the cable office or in or about the amplifiers between the cable office and a house, building, or other place where televisions are located. Television picture or image vision prescription is made in or about fiber-optic cables. Similar to television signal scrambling in which slightly offset signals are inserted using the scrambling system to interfere with the television picture and channel's frequency and then may be filtered out for a clear picture, television vision prescription signals may be similarly applied to broadcast television signals.

Television vision prescription broadcast and transmitted signals are also produced for HDTV, flat television, DVDs, and digital processing. Vision prescription television screen dimensions are made such that the screen fits the television in question or the appropriate aspect ratio or the required television screen. Vision prescription pictures or images are also made for lighter and larger screen formats, as well as in the signal converting process including digital to analog and analog to digital conversion. Vision prescription pictures or images are produced in or about the coaxial cable and fiber optic cable.

Vision prescription television picture or image screens and receivers that stand alone are made considering the above descriptions for vision prescription screens, receiving, and broadcasting components. The invention is made to allow variation of the vision prescription.

### CROSS-REFERENCES TO RELATED APPLICATIONS

1. Lee, 2000. “Monitor output device in high-definition television”, U.S. Pat. No. 6,067,123.
2. Kim, et al., 2000. “Automatic picture size control method for semiwide-screen television receiver”, U.S. Pat. No. 6,064,445.
3. Bando, et al., 2000. “Television signal receiving apparatus and method specification”, U.S. Pat. No. 6,040,867.
4. Hamill, 1978. “Precise control of television picture size and position”, U.S. Pat. No. 4,085,425.
5. Hutt, et al., 1977. “Television receiver system having facility for storage and display of character information selected from digitally encoded broadcast transmissions”, U.S. Pat. No. 4,052,719.
6. Bogner, 1989. “Method of simultaneous depiction of at least two temporally sequential events on television, and equipment for implementing this method”, U.S. Pat. No. 4,843,483.
7. Dougherty, and Jackson, 1948. “Apparatus for magnifying the images on television screens”, U.S. Pat. No. 2,449,886.
8. Inglis, 1977. “Magnification of television images”, U.S. Pat. No. 4,051,535.

1. A television picture or image enhancing system comprising:
a device which varies or allows the variation of the perception as in a prescription for vision of the pictures or images on or from a television screen,

2. The television picture or image enhancing system described in claim 1, wherein the vision prescription may not vary,

3. The television picture or image enhancing system described in claim 1, wherein the system may be attached directly to a television,

4. The television picture or image enhancing system described in claim 1, wherein the system may not be attached directly to a television,

5. A television picture or image enhancing system comprising:
a device which varies or allows the variation of the perception as in a prescription for vision of the pictures or images on or from a television screen through broadcasted television signal manipulation,

6. The television picture or image enhancing system described in claim 5, wherein the vision prescription may not vary.

7. The television picture or image enhancing system described in claim 5, wherein the system may be attached directly to a television,

8. The television picture or image enhancing system described in claim 5, wherein the system may not be attached directly to a television,

9. A television picture or image enhancing system comprising:
a television screen which may exist alone as a prescription television signal receiver and viewing surface only.
